(19) United States
(12) Patent Application Publication
(10) Pub. No.: US 2017/0285716 A1
(43) Pub. Date: Oct. 5, 2017

(54) ELECTRONIC OUTLET PLACE HOLDER

(71) Applicant: Louis H. Beale, Bowie, MD (US)

(72) Inventor: Louis H. Beale, Bowie, MD (US)

(21) Appl. No.: 14/698,023

(22) Filed: Apr. 28, 2015

(51) Int. Cl. G06F 1/32; H01R 13/703; H02J 9/00; H01R 13/66; H02H 3/12

(52) U.S. Cl. CPC G06F 1/3203; H01R 13/6683; H02H 3/12; H02J 9/005; H01R 13/7036

(57) ABSTRACT

A plug in power strip that prevents electricity from traveling to an appliance when not in use is disclosed. The power strip may use either sensor technology or a manually operated switch that when an appliance is unused will be alerted and will prevent electricity from traveling to the appliance, thus not wasting energy. The resulting shut off will save energy, save money and be safer for homeowners. When the user deems it useful to begin using the appliance once again, the plug in power strip will re-open the channel to let electricity back into that specific appliance. Therefore, the plug in power strip of the present invention keeps optimally keeps appliances running, but does not waste electricity.

### FIELD OF THE INVENTION

The present invention relates generally to using appliances more efficiently by developing a plug holder that will automatically shut off all unused appliances.

### BACKGROUND OF THE INVENTION

A major source of energy waste is when homeowners leave appliances on unused. After watching several commercials about appliances, the idea of an electrical outlet that could shut off its own power supply came to mind. The appliances when not in use are still running and use energy, thus wasting energy. The unused appliances can be inefficient, costly, energy wasting and even unsafe. A major problem with leaving lots of appliances unused is the possibility of the appliances reacting unsafely, perhaps even catching on fire and harming a user. Also, when numerous appliances are plugged in, it is possible to lose money for all the energy bills that must be covered for leaving the appliances plugged in. In addition, wasting energy is harmful to our environment, and with a looming future energy crisis, energy needs to be saved whenever possible.

While the method of unplugging every appliance in the kitchen is extremely effective, it is not time efficient as if someone has a lot of appliances they must spend a good portion of time plugging all the appliances back into their respective outlets. Additionally, while unplugging appliances is effective, it may not be safe. If the unplugged appliance is left in an area where this is a lot of liquid, users may be electrocuted by accident. A device like this would be sold in a store that typically sells kitchen appliances or electrical devices. Therefore, a need exists for a device which is truly unique in managing the use of appliances that saves money and energy.

### SUMMARY

A plug in power strip that prevents electricity from traveling to an appliance when not in use is disclosed. The power strip may use either sensor technology or a manually operated switch that when an appliance is unused will be alerted and will prevent electricity from traveling to the appliance, thus not wasting energy. The resulting shut off will save energy, save money and be safer for homeowners. When the user deems it useful to begin using the appliance once again, the plug in power strip will re-open the channel to let electricity back into that specific appliance. Therefore, the plug in power strip of the present invention keeps optimally keeps appliances running, but does not waste electricity.

### BRIEF DESCRIPTION OF THE DRAWINGS

All illustrations of the drawings are for the purpose of describing selected versions of the present invention and are not intended to limit the scope of the present invention.

FIG. 1 is a graphical representation of a typical household electric outlet and electrical outlet plate.

FIG. 2 is a graphical representation of the layout for the electronic outlet place holder.

### DETAIL DESCRIPTIONS OF THE INVENTION

Having numerous kitchen appliances has become the norm in a standard household today. With numerous kitchen appliances, the efficiency of making meals or making snacks has allowed the average user to quickly make a meal and continue on with other tasks. Many kitchen appliances use an array of different energy supply amounts, and over time, the use of all the energy can become extremely expensive.

People often find themselves having to pay more for energy costs because of all the appliances that are left plugged into the wall outlets and also may face safety problems because having numerous appliances consistently plugged in could be a fire hazard if a fuse were to blow. The present invention overcomes this problem by providing a method of shutting off appliances that are not in use and then will turn on the appliances when it deems necessary. The invention may fit over a present wall outlet and can allow multiple appliances to plug into the device. The invention will be able to shut off individual outlets and still allow other outlets on the strip to remain on. While the invention will predominantly be used in the kitchen, this invention is not limited to being used for only kitchen appliances, but can be used anywhere there are multiple appliances that require power to be used.

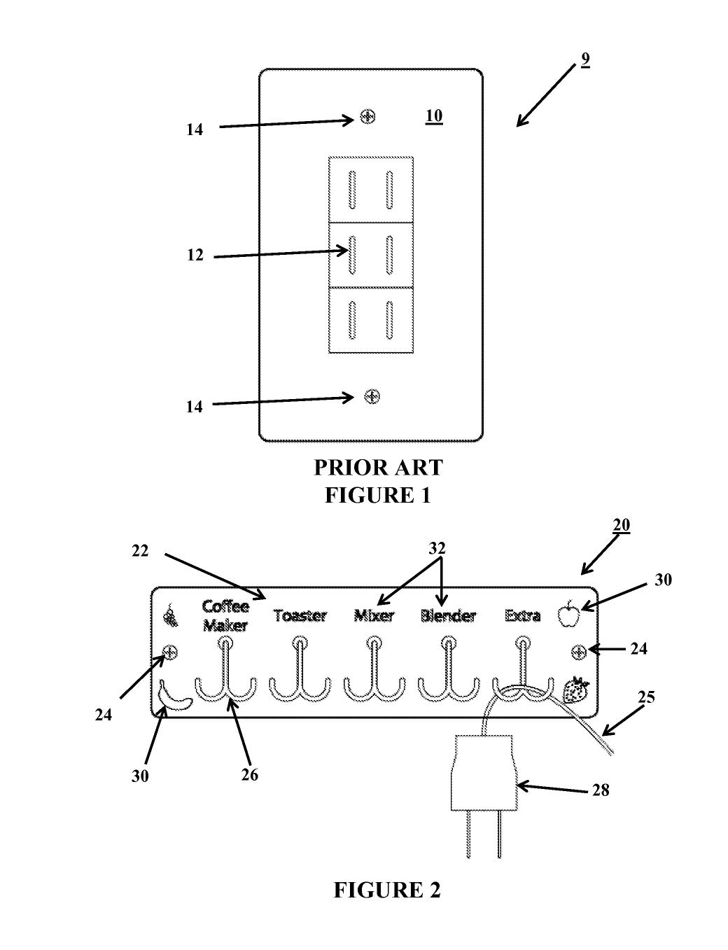

Referring now to FIGS. 1 and 2, there is shown a graphical representation of a prior art household electric outlet plate 9 comprised of a plastic cover 10, and outlet plug-ins 12. The plastic cover 10 goes over the electrical outlet plug-ins 12 and will house a circuit (not shown) and attached vertically to a wall by use of screws 14. Referring now to FIG. 2, there is shown power strip 20 in accordance with the present invention which is attached horizontally to the wall using screws 24 and comes in multiple colors to match certain kitchen decors. As shown in FIG. 2, the plastic cover 22 may include images 30 of designs of fruit across the power strip 20 as an aesthetic touch. Additionally, the cover 22 may include a stain resistant or water resistant design to help block against accidents that may occur in a kitchen. Above each outlet will be a label 32 for each application that is in use within each outlet.

Turning once again to FIG. 2, in one preferred embodiment cover 22 may be approximately 6 inches long and 1.5 to 1.75 inches wide and will promptly fit over an existing wall outlet plate. It should be understood that each outlet will be comprised of a standard electric outlet insert 26. The inserts 26 will be placed in a typical wall outlet format. Horizontally placed, there will be 5 to 6 plug ins that will be placed next to each other for ease of access and also to save space. As shown in FIG. 2, they will be three pronged and may be able to accommodate for different electric outlet heads (not shown). The electric outlets 12 will be comprised of a multitude of proposed different ways of managing the power shut off of unused appliances. Although not shown, it may be envisioned that power strip 20 has a manual switch above each of the outlets to shut off the individual power supply for a specific appliance that is unused may be incorporated into the cover 22. With the inclusion of a manual switch (not shown), a user can ensure that the power supply for that specific outlet has been switched off. The outlet will only come back on in the instance that the user flips the switch back into the on position, allowing the power flow to come back. In yet another preferred embodiment, a method to shut off the power would be if the appliance contains the ability to be switched off from the appliance's own control area, then the power strip 20 using smart sensor technology, will notify itself to shut off the power source for that specific outlet. The power strip 20 may also, if conditions are meet shut itself off completely by itself if too much power is being wasted, or if the amount of power running is unsafe for a homeowner and therefore shuts itself off as a safety precaution. The power strip 20 may also have the option of completely shutting off by flipping a complete power off switch (not shown). Therefore, the power feed would be stopped for every appliance and none of the appliances would then get power.

The plug-ins or inserts 26 on the back of the power strip will comprise of a typical three pronged tip plug in for a typical wall outlet. The plug-ins 26 will fit on a standard wall outlet, as shown in FIG. 2 and can feature adapters for other nonconventional outlet sources. This way the power strip 20 will be available to use in numerous of other countries and also where there may be unconventional outlets in American homes. The amount of three pronged outlets 26 could be varied, depending on how big the eventual power strip 20 design turns out to be and also how much energy is required for the strip 20 to power all the appliances plugged in. The power strip outlet 20 will then also be able to be screwed into the wall to completely fasten the design to the wall by screws 24 as described above. The screws 24 to the wall will most likely replace a standard outlet plate in a home environment like the one shown in FIG. 2, however may be able to be applied over a conventional outlet plate.

The power strip 20 may be composed from any material that meets the durability requirements of use in a homeowner's typical kitchen. A rather useful material would be plastic, however the design's material is not only limited to plastic but could be made from other materials such as synthetic materials, heavy duty metal etc. The materials used for the plastic cover 22 can also be a combination of materials such as plastic with a metal core. The power strip plug-ins 26 will be made from a typical plug in metal although it could also be made from another similarly conductive material if decided upon. The power strip's 20 design weight will be relatively light, around 5 ounces; however the weight will be designated to change and is not a permanent aspect of the design. In still yet another preferred, the plug ins 26 may are designed to hold a power cord 25 for an appliance's plug 28 that has been pulled out from an outlet which will also completely turn off an appliances power.

Although the invention has been explained in relation to its preferred embodiment, it is to be understood that many other possible modifications and variations can be made without departing from the spirit and scope of the invention. Obvious changes, modifications and substitutions can be made by those who deem it necessary to achieve the same utility of the invention. The current embodiments are examples and are not intended to limit the scope of the invention.

What is claimed is:

1. An electronic outlet place holder for use with appliances, comprising
a plug in power strip that prevents electricity from traveling to an appliance when not in use.

2. The outlet holder according to claim 1 wherein said power strip uses sensor technology such that when an appliance is unused it will prevent electricity from traveling to the appliance, thus not wasting energy

3. The outlet holder according to claim 1 wherein said power strip uses a manually operated switch such that when an appliance is unused it will prevent electricity from traveling to the appliance, thus not wasting energy,

4. The outlet holder according to claim 1 wherein said power strip uses sensor technology such that when an appliance is used it allows electricity to power the appliance, thus not wasting energy

5. The outlet holder according to claim 1 wherein said power strip uses a manually operated switch such that when an appliance is used it allows electricity to power the appliance, thus not wasting energy

6. The outlet holder according to claim 1 wherein said power strip includes an outlet cover which is approximately 6 inches long and 1.5 to 1.75 inches wide and fits over an existing wall outlet plate.

7. The outlet holder according to claim 1 further comprising:
a plurality of electric outlet inserts wherein said inserts will be placed and attached horizontally against a wall outlet format and defines five to six plug ins that will be placed next to each other for ease of access to save space.

8. The outlet holder according to claim 1 further comprising:
a plurality of plug-ins on the back of said power strip,
said plurality of plug-ins defining a standard American three pronged tip plug in for use in a American standard wall outlet.

9. The outlet holder according to claim 1 a plurality of plug-ins on the back of said power strip,
said plurality of plug-ins defining a standard International standard three pronged tip plug in for use in an International standard wall outlet.
